(19) United States
(12) Patent Application Publication
(10) Pub. No.: US 2013/0249862 A1
(43) Pub. Date: Sep. 26, 2013

(54) Dynamic Impedance Circuit

(71) Applicants: Ming Xu, Shanghai (CN); Roger L. Franz, Mundelein, IL (US); Scott N. James, Arlington Heights, IL (US); Mark F. Valentine, Kenosha, WI (US)

(72) Inventors: Ming Xu, Shanghai (CN); Roger L. Franz, Mundelein, IL (US); Scott N. James, Arlington Heights, IL (US); Mark F. Valentine, Kenosha, WI (US)

(73) Assignee: Motorola Mobility LLC, Libertyville, IL (US)

(21) Appl. No.: 13/892,165

(22) Filed: May 10, 2013

Related U.S. Application Data
(63) Continuation of application No. PCT/CN2010/078690, filed on Nov. 12, 2010.

(51) Int. Cl. H01H 47/00; G06F 3/041; H02J 7/00

(52) U.S. Cl. CPC H01H 47/00; H02J 7/007; G06F 3/0412
USPC 345/174; 307/130; 307/109; 320/137

(57) ABSTRACT

In embodiments of a dynamic impedance circuit, a power circuit of a device charges and/or powers the device when the device is connected to a power source. A dynamic impedance circuit is coupled to the power circuit of the device and to the power source. The dynamic impedance circuit can operate with low impedance, and alternatively, can operate with high impedance responsive to an increased voltage across the dynamic impedance circuit, such as when a chassis of the device is coupled to ground.

### BACKGROUND

Devices having an integrated, capacitive touch-screen, such as mobile phones, handheld navigation devices, and portable music players are increasingly popular. When such a device is plugged-in to an AC power source, such as to charge a battery of the device and/or to power the device, common mode noise may be generated that causes display jitter and/or is sensed as a false touch input to a capacitive touch-screen of the device. One possible solution to reduce common mode noise is to utilize a common mode inductor. However, the expense associated with such a component can increase the production cost of a device to a point that this is not a viable solution. Another conventional solution is to utilize a Y-capacitor. However, this component solution has been determined to increase leakage current, which may give a user a feeling of an electrical shock when the user makes direct electrical contact with a device that is connected to a charger.

### BRIEF DESCRIPTION OF THE DRAWINGS

Embodiments of a dynamic impedance circuit are described with reference to the following drawings. The same numbers are used throughout the drawings to reference like features and components:

FIG. 1 illustrates an example system in which embodiments of a dynamic impedance circuit can be implemented.

FIG. 2 illustrates an example powered device in which embodiments of a dynamic impedance circuit can be implemented.

FIG. 3 illustrates a representation of a first operational state of a dynamic impedance circuit when a device is powered by a switching power source, and a chassis of the device is coupled to ground.

FIG. 4 illustrates a representation of a second operational state of a dynamic impedance circuit when a device is powered by a switching power source, and without a chassis of the device coupled to ground.

FIG. 5 illustrates another representation of the second operational state of the dynamic impedance circuit with a touch input to a capacitive touch-screen of the device, and without the chassis of the device coupled to ground.

FIG. 6 illustrates examples of dynamic impedance circuits implemented with junction-gate field effect transistors (JFETs) in accordance with one or more embodiments.

FIG. 7 illustrates examples of dynamic impedance circuits implemented with varactor diodes in accordance with one or more embodiments.

FIG. 8 illustrates examples of dynamic impedance circuits implemented with negative differential resistance components in accordance with one or more embodiments.

FIG. 9 illustrates a results chart that includes an approximation of leakage current, low-frequency common mode noise, and high-frequency common mode noise when a dynamic impedance circuit is implemented with varactor diodes, and when a chassis of a device is coupled to ground and without the chassis of the device coupled to ground.

FIG. 10 illustrates a results chart that includes an approximation of impedance when a dynamic impedance circuit is implemented with junction-gate field effect transistors (JFETs), and when a chassis of a device is coupled to ground and without the chassis of the device coupled to ground.

FIG. 11 illustrates example method(s) in accordance with one or more embodiments.

FIG. 12 illustrates various components of an example device that can implement embodiments of a dynamic impedance circuit.

### DETAILED DESCRIPTION

In embodiments of a dynamic impedance circuit, a power circuit of a device charges and/or powers the device when the device is connected to a power source. For example, a mobile phone can be plugged-in to an AC power source to charge a battery of the device and/or to power the device. A dynamic impedance circuit is coupled to the power circuit of the device and to the power source. The dynamic impedance circuit operates with low impedance, and alternatively, operates with high impedance responsive to an increased voltage across the dynamic impedance circuit, such as when a chassis of the device is coupled to ground.

Various implementations of dynamic impedance circuits are described herein. Generally, a dynamic impedance circuit exhibits low impedance when a voltage across the circuit is minimal or decreases, and current is then increased. Alternatively, the dynamic impedance circuit exhibits high impedance when the voltage across the circuit increases, and current is then decreased. The voltage across a dynamic impedance circuit increases when a chassis of a device is capacitively coupled to ground, such as when user contact with the chassis of the device capacitively couples the device to ground. A dynamic impedance circuit can reduce current flow, such as leakage current, at least when the dynamic impedance circuit operates with high impedance. The dynamic impedance circuit can also attenuate common mode noise at least when the dynamic impedance circuit operates with low impedance.

In embodiments, a dynamic impedance circuit can be implemented with circuit components that include varactor diodes, junction-gate field effect transistors (JFETs), or a negative resistor. Optionally, a Y-capacitor may be coupled in series with any of the dynamic impedance circuits to electrically isolate a device from a power source in an event the power circuit in the device fails.

While features and concepts of the described dynamic impedance circuits can be implemented in any number of different devices, systems, and/or configurations, embodiments of a dynamic impedance circuit are described in the context of the following example devices, systems, and methods.

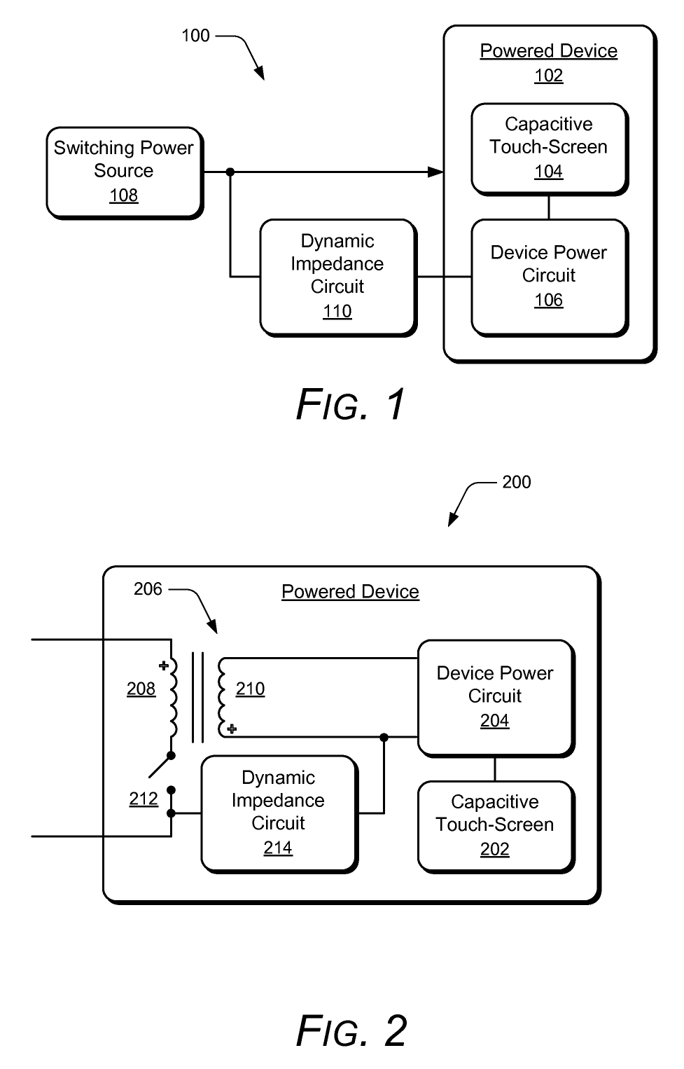

FIG. 1 illustrates an example system 100 in which embodiments of a dynamic impedance circuit can be implemented. The example system 100 includes a powered device 102 that includes a capacitive touch-screen 104 and a device power circuit 106. The capacitive touch-screen senses the position of a touch input to the touch-screen of the device, such as a user input to a user interface image that is displayed on the touch-screen. The power circuit of the device is connected to a switching power source 108, such as when a mobile phone is plugged-in to an AC power source to charge a battery of the device and/or to power the device. The powered device may be any type of portable device, such as a mobile phone, handheld navigation device, and/or portable media playback device. The powered device may also be any type of device as further described with reference to the example device shown in FIG. 12.

The example system 100 also includes a dynamic impedance circuit 110 that is coupled to the switching power source 108 and to the device power circuit 106. The dynamic impedance circuit may be implemented as a circuit of the powered device 102, such as part of the device power circuit along with an integrated power supply. The dynamic impedance circuit may also be integrated in a system-on-chip (SoC) with other components and/or logic of the device. Alternatively, the dynamic impedance circuit may be implemented as a circuit of the switching power source, such as part of a power supply that is external to the powered device. In embodiments, the dynamic impedance circuit is implemented to operate with low impedance in a first operational state. The dynamic impedance circuit is also implemented to operate with high impedance in a second operational state, such as when a voltage across the dynamic impedance circuit increases, which is also the voltage difference between the device power circuit and the switching power source.

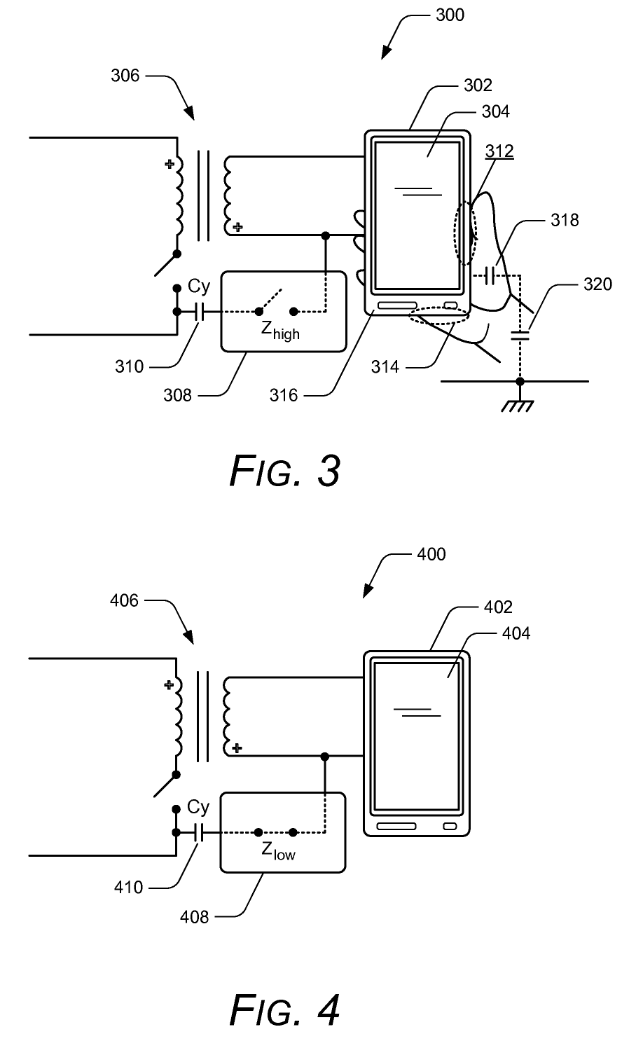

FIG. 2 illustrates an example powered device 200 in which embodiments of a dynamic impedance circuit can be implemented. The example device 200 is a powered device that includes a capacitive touch-screen 202 implemented to sense a touch input. The example device also includes a device power circuit 204 that couples to an integrated, switching power supply 206, which powers and/or charges a battery in the device, such as when the device is connected to a power source. In this example, the switching power supply includes a transformer having a transformer primary 208 that connects to an external power source and a transformer secondary 210 that couples to the device power circuit. The switching power supply also includes a regulator switch 212 that opens and closes to regulate an output voltage based on device loading.

The example device 200 includes a dynamic impedance circuit 214, which is coupled to the switching power supply 206 and to the device power circuit 204. Specifically, the dynamic impedance circuit is coupled between the transformer primary 208 of the switching power supply and the transformer secondary 210 of the switching power supply. The powered device may include the dynamic impedance circuit as an independent circuit or integrated in an SoC with other components and/or logic of the device. As described with reference to the dynamic impedance circuit shown in FIG. 1, the dynamic impedance circuit 214 is implemented to operate with low impedance in a first operational state, and operate with high impedance in a second operational state, such as when a voltage across the dynamic impedance circuit increases. In this example, the voltage across the dynamic impedance circuit is also the voltage difference between the device power circuit and the switching power supply, which is connected to an external power source.

FIG. 3 illustrates a representation 300 of a first operational state of a dynamic impedance circuit when a chassis of the device is coupled to ground. The representation 300 includes a powered device 302 with an integrated capacitive touch-screen 304, and includes a switching power supply 306. The powered device may be implemented as described with reference to devices 102 or 200 shown in respective FIGS. 1 and 2. The switching power supply connects to an external power source and couples to a device power circuit in the powered device to charge a battery in the device and/or to power the device.

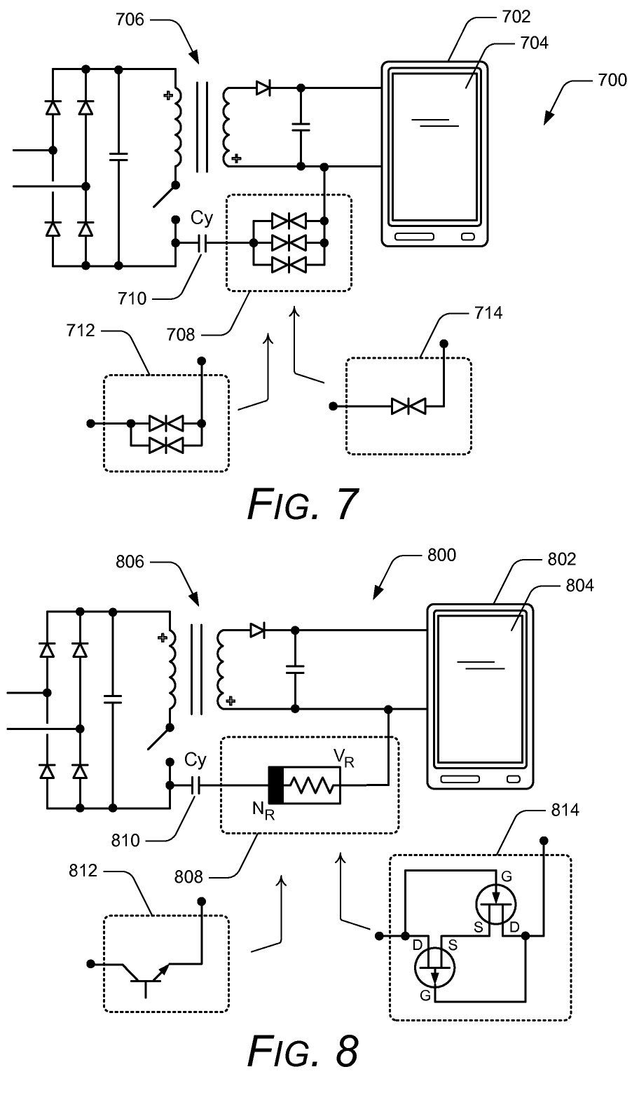

The representation 300 also includes a dynamic impedance circuit 308 and an optional Y-capacitor 310 coupled in series with the circuit. The Y-capacitor may be included to electrically isolate the device 302 from a power source in an event the power circuit in the device fails. Similar to the powered device shown in FIG. 2, the powered device 302 may be implemented to include the switching power supply 306, the dynamic impedance circuit 308, and/or the Y-capacitor as integrated components. Additionally, the Y-capacitor may be implemented as a component of the dynamic impedance circuit. The dynamic impedance circuit 308 operates with high impedance, and is illustrated as an open circuit merely to represent the high impedance. When the circuit is implemented as any of the various dynamic impedance circuits described herein, such as with reference to FIGS. 6-8, the first operational state may not reach the operating range of a completely open switch.

The dynamic impedance circuit 308 operates with high impedance when a voltage across the circuit increases, which is also a voltage difference between the device and the power source. The dynamic impedance circuit exhibits negative impedance and an increase in the voltage across the dynamic impedance circuit results in a decrease in current through the circuit, such as a decrease in leakage current. The voltage across the dynamic impedance circuit increases when user contact at 312 and/or 314 with a chassis 316 of the device capacitively couples the device to ground, as represented by capacitors 318, 320 in the illustration. The chassis of the device is conductive and, either directly or indirectly (including inductively), is coupled to the device power circuit. A high-frequency component of the common mode noise that may otherwise cause display jitter is shunted to ground when the device is capacitively coupled to ground. The capacitance between the device and ground is relatively large and the common mode noise, such as generated from a charging device, has little to no impact on the function of the capacitive touch-screen of the device. The chassis of a device may also be referred to as a housing portion, an outer casing, a shell, or other similar structures that define a form factor of the device and that a user contacts when holding the device.

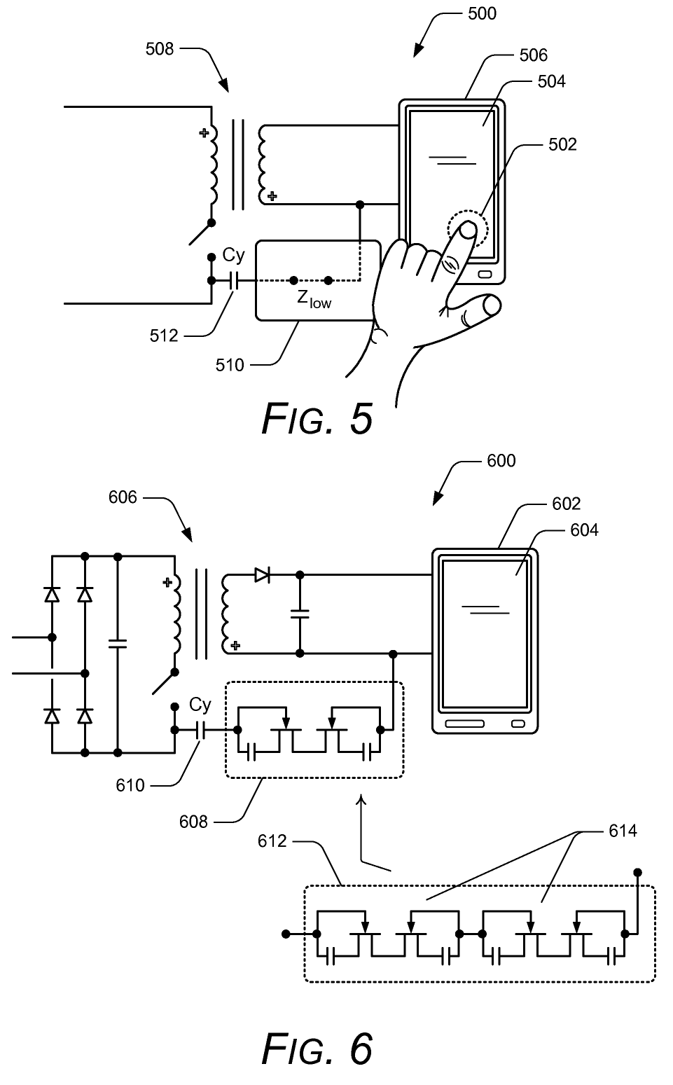

FIG. 4 illustrates a representation 400 of a second operational state of a dynamic impedance circuit without the chassis of the device coupled to ground. The representation 400 includes a powered device 402 with an integrated capacitive touch-screen 404, and includes a switching power supply 406. The powered device may be implemented as described with reference to devices 102 or 200 shown in respective FIGS. 1 and 2. The switching power supply connects to an external power source and couples to a device power circuit in the powered device to charge a battery in the device and/or to power the device.

The representation 400 also includes a dynamic impedance circuit 408 and an optional Y-capacitor 410 coupled in series with the circuit. The Y-capacitor may be included to electrically isolate the device 402 from a power source in an event the power circuit in the device fails. Similar to the powered device shown in FIG. 2, the powered device 402 may be implemented to include the switching power supply 406, the dynamic impedance circuit 408, and/or the Y-capacitor as integrated components. Additionally, the Y-capacitor may be implemented as a component of the dynamic impedance circuit.

The dynamic impedance circuit 408 operates with low impedance, and is illustrated as a short circuit merely to represent the low impedance. When the circuit is implemented as any of the various dynamic impedance circuits described herein, such as with reference to FIGS. 6-8, the second operational state may not reach the operating range of a completely closed switch. The dynamic impedance circuit 408 operates with low impedance when a voltage across the circuit is minimal or decreases, and current is increased. The dynamic impedance circuit also attenuates common mode noise at least when the circuit operates with low impedance.

FIG. 5 illustrates another representation 500 of the second operational state of the dynamic impedance circuit with a touch input 502 to a capacitive touch-screen 504 of a powered device 506, and without the chassis of the device coupled to ground. The representation illustrates that a user may initiate a touch input to the touch-screen of the device without holding the device in the other hand, such as shown in FIG. 3, or generally, without contacting the chassis of the device that would otherwise capacitively couple the device to ground. For example, a mobile phone with a capacitive touch-screen may be plugged-in to a power source and placed on a desk or table. The user may then initiate touch-screen inputs on the device with one hand without picking up the device in the other hand.

The representation 500 also includes a switching power supply 508, a dynamic impedance circuit 510 operating with a low impedance, and an optional Y-capacitor 512 coupled in series with the dynamic impedance circuit. The switching power supply, dynamic impedance circuit, and Y-capacitor may all be implemented as described with reference to the respective components shown in FIG. 4. The dynamic impedance circuit 510 continues to operate with low impedance because there is no user contact with the chassis of the device that would otherwise capacitively couple the device to ground.

FIG. 6 illustrates examples 600 of dynamic impedance circuits implemented with junction-gate field effect transistors (JFETs). The examples 600 include a powered device 602 with a capacitive touch-screen 604, and include a switching power supply 606. The powered device and the switching power supply may be implemented as described with reference to any of the FIGS. 1-5. In the examples 600, a dynamic impedance circuit 608 is implemented with JFETs, and an optional Y-capacitor 610 is coupled in series with the dynamic impedance circuit. The circuit can operate with a high capacitance to reduce common mode noise, and leakage current is reduced as a voltage across the dynamic impedance circuit increases. In implementations, conducted current is restricted when the voltage between the gate and the source of a JFET increases (i.e., is larger than the pinch-off voltage turning the JFET off), which restricts the conducted current.

An alternative dynamic impedance circuit 612 is implemented with multiple configurations of the circuit components 614 (the JFETs) of the dynamic impedance circuit 608 connected in series. As described with reference to the device shown in FIG. 2, the powered device 602 may include a dynamic impedance circuit, either as an independent circuit or integrated in an SoC with other components and/or logic of the device. Additionally, the dynamic impedance circuits 608 and 612 may be implemented as any of the dynamic impedance circuits described with reference to FIGS. 1-5.

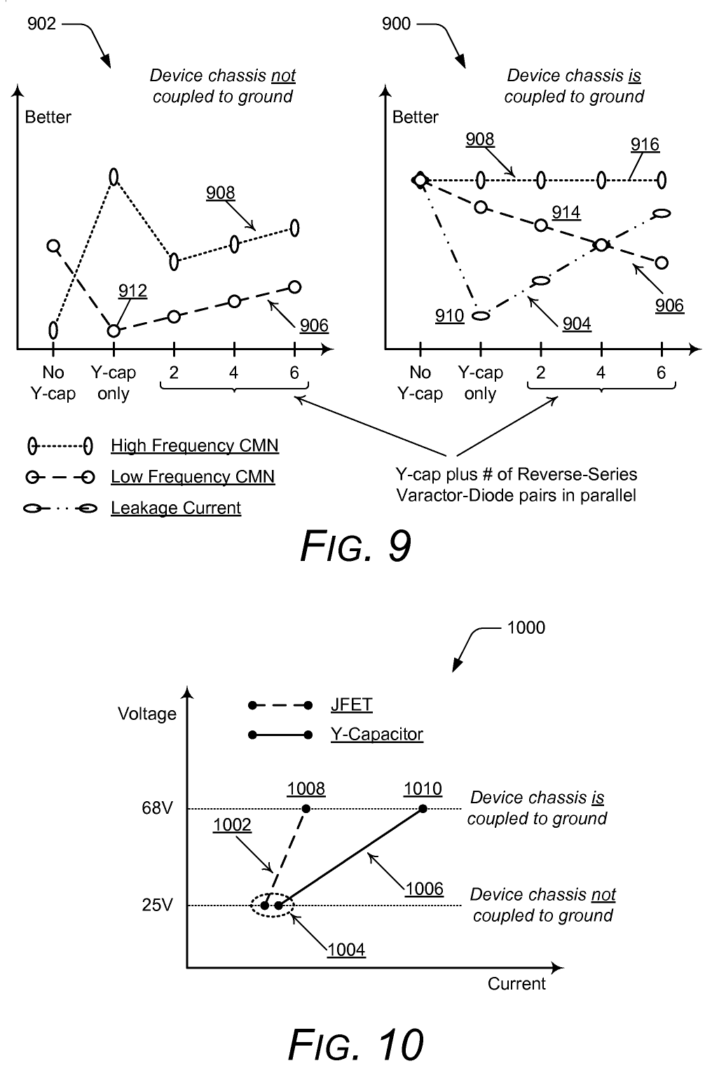

FIG. 7 illustrates examples 700 of dynamic impedance circuits implemented with varactor diodes. The examples 700 include a powered device 702 with a capacitive touch-screen 704, and include a switching power supply 706. The powered device and the switching power supply may be implemented as described with reference to any of the FIGS. 1-5. In the examples 700, a dynamic impedance circuit 708 is implemented as a six-varactor diode circuit, and an optional Y-capacitor 710 is coupled in series with the dynamic impedance circuit. A varactor diode can be used as a voltage-controlled capacitor, and operates with variable-junction capacitance when reverse biased. This characteristic can be utilized to reduce common mode noise. In implementations, varactor diodes having a wide dynamic range can be utilized, such as a range of 20 pF at 1 volt, and 1 pF at 20 volts. Additionally, the varactor diodes can be arranged in series or parallel circuit configurations to implement a dynamic impedance circuit for a first operational state (e.g., as described with reference to FIG. 3) and a second operational state (e.g., as described with reference to FIGS. 4 and 5).

An alternative dynamic impedance circuit 712 is implemented as a four-varactor diode circuit, and another alternative dynamic impedance circuit 714 is implemented as a two-varactor diode circuit. As described with reference to the device shown in FIG. 2, the powered device 702 may include a dynamic impedance circuit, either as an independent circuit or integrated in an SoC with other components and/or logic of the device. Additionally, the dynamic impedance circuits 708, 712, and 714 may be implemented as any of the dynamic impedance circuits described with reference to FIGS. 1-5.

FIG. 8 illustrates examples 800 of dynamic impedance circuits implemented with negative differential resistance components. The examples 800 include a powered device 802 with a capacitive touch-screen 804, and include a switching power supply 806. The powered device and the switching power supply may be implemented as described with reference to any of the FIGS. 1-5. In the examples 800, a dynamic impedance circuit 808 is implemented with a negative resistor, and an optional Y-capacitor 810 is coupled in series with the dynamic impedance circuit. An alternative dynamic impedance circuit 812 is implemented with a negistor element, which in this example is a two-terminal negative resistance element. The emitter and collector terminals of the bipolar transistor are connected, while the base terminal is unconnected. Another alternative dynamic impedance circuit 814 is implemented with complementary N- and P-channel JFETs configured as a lambda diode having a negative differential resistance.

As described with reference to the device shown in FIG. 2, the powered device 802 may include a dynamic impedance circuit, either as an independent circuit or integrated in an SoC with other components and/or logic of the device. Additionally, the dynamic impedance circuits 808, 812, and 814 may be implemented as any of the dynamic impedance circuits described with reference to FIGS. 1-5.

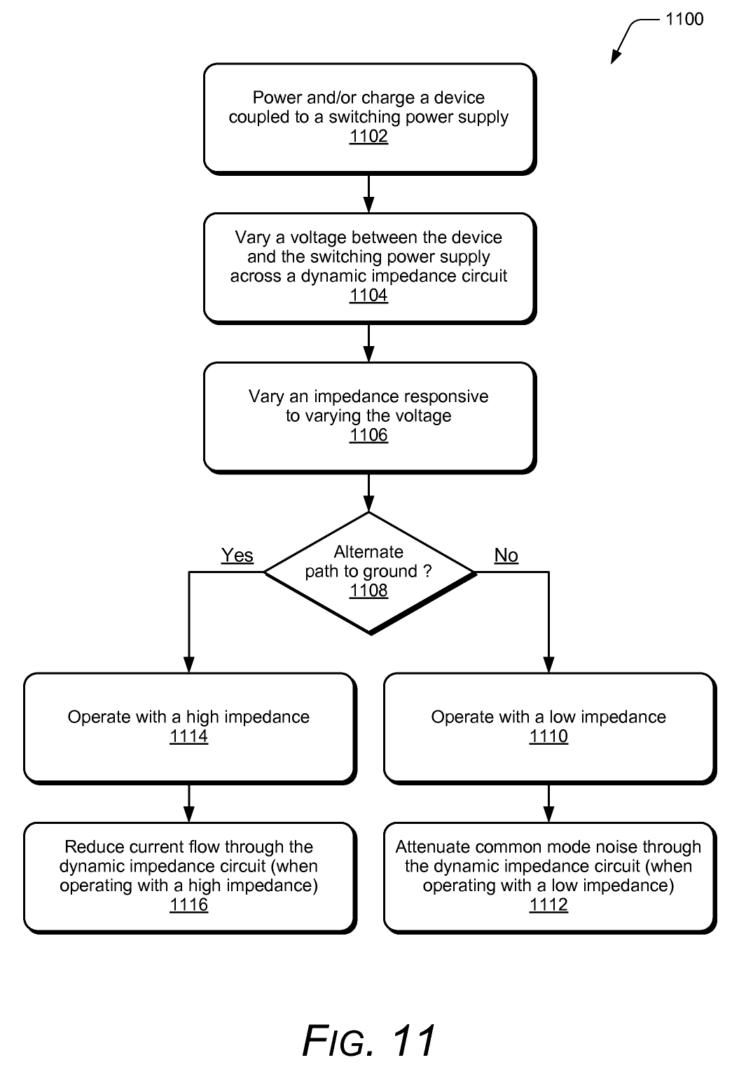

FIG. 9 illustrates results charts 900 and 902 that include an approximation of leakage current 904, low-frequency common mode noise 906, and high-frequency common mode noise 908 when a dynamic impedance circuit is implemented with varactor diodes, such as shown implemented in FIG. 7. The results chart 900 illustrates the results when a chassis of a device is coupled to ground, and the results chart 902 illustrates the results without the chassis of the device coupled to ground. The results charts 900 and 902 also illustrate leakage current and common mode noise for implementations without a dynamic impedance circuit, such as for an implementation with only a Y-capacitor and for an implementation without a Y-capacitor.

The results chart 900 illustrates that the leakage current 904, when user contact with the chassis of the device capacitively couples the device to ground, decreases as a dynamic impedance circuit is implemented with more varactor diodes. A decrease in leakage current is illustrated as an improvement in the results chart. In this instance, the leakage current 904 is better when a dynamic impedance circuit is implemented with a six-varactor diode circuit, such as the dynamic impedance circuit 708 shown in FIG. 7. Note that the leakage current 904 is improved with implementation of a dynamic impedance circuit as opposed to the leakage current at 910 for a Y-capacitor implementation only (i.e., no dynamic impedance circuit).

The results chart 902 illustrates that the low-frequency common mode noise 906, when the chassis of the device is not coupled to ground, decreases as a dynamic impedance circuit is implemented with more varactor diodes. A decrease in common mode noise is illustrated as an improvement in the results chart. In this instance, the low-frequency common mode noise 906 is better when a dynamic impedance circuit is implemented with a six-varactor diode circuit, such as the dynamic impedance circuit 708 shown in FIG. 7. Note that the low-frequency common mode noise 906 is improved with implementation of a dynamic impedance circuit as opposed to the low-frequency common mode noise at 912 for a Y-capacitor implementation only (i.e., no dynamic impedance circuit).

Alternatively, the low-frequency common mode noise 906 increases as a dynamic impedance circuit is implemented with more varactor diodes when the chassis of the device is coupled to ground, as shown in the results chart 900. In this instance, the low-frequency common mode noise 906 is better at 914 when a dynamic impedance circuit is implemented with a two-varactor diode circuit, such as the dynamic impedance circuit 714 shown in FIG. 7. Note that the low-frequency common mode noise 906 is overall decreased when the chassis of the device is coupled to ground as compared to when the chassis of the device is not coupled to ground.

The results chart 902 illustrates that the high-frequency common mode noise 908, when the chassis of the device is not coupled to ground, improves as a dynamic impedance circuit is implemented with more varactor diodes. The results chart 900 illustrates that the high-frequency common mode noise 908, when the chassis of the device is coupled to ground, remains approximately constant at 916 as a dynamic impedance circuit is implemented with more varactor diodes. Note that the high-frequency common mode noise 908 is overall decreased when the chassis of the device is coupled to ground as compared to when the chassis of the device is not coupled to ground.

FIG. 10 illustrates a results chart 1000 that includes an approximation of impedance when a dynamic impedance circuit is implemented with junction-gate field effect transistors (JFETs), such as shown implemented in FIG. 6, and when a chassis of a device is coupled to ground and without the chassis of the device coupled to ground. The results chart 1000 illustrates that for a JFET implementation 1002 of a dynamic impedance circuit, when the chassis of the device is not coupled to ground, the impedance at 1004 is approximately the same as for a simple Y-capacitor implementation 1006 (i.e., no dynamic impedance circuit). The JFET implementation 1002 and the simple Y-capacitor implementation 1006 have a similar suppression effect on common mode noise when the chassis of the device is not coupled to ground at 1004.

The results chart 1000 also illustrates that when the chassis of a device is coupled to ground, such as when user contact with the chassis of the device capacitively couples the device to ground, the impedance at 1008 of the JFET implementation 1002 is greater than the impedance at 1010 of the simple Y-capacitor implementation 1006. The greater impedance at 1008 of the JFET implementation 1002 suppresses leakage current.

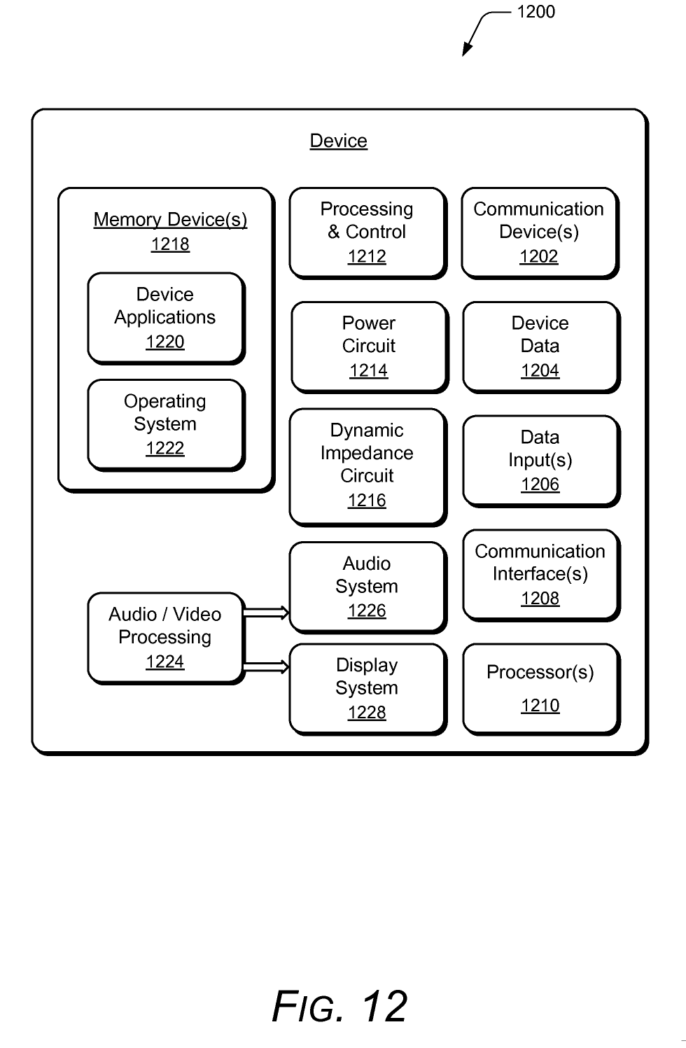

FIG. 11 illustrates example method(s) 1100 of a dynamic impedance circuit. The order in which the method blocks are described are not intended to be construed as a limitation, and any number or combination of the described method blocks can be combined in any order to implement a method, or an alternate method.

At block 1102, a device coupled to a switching power supply is powered and/or charged. For example, the power circuit 106 (FIG. 1) of the powered device 102 is connected to the switching power source 108, such as when the device is plugged-in to an AC power source, which charges a battery of the device and/or powers the device.

At block 1104, a voltage is varied between the device and the switching power supply across a dynamic impedance circuit, which is coupled to the device and to the switching power supply. For example, the voltage across the dynamic impedance circuit 110 that is coupled to the switching power source 108 and to the device power circuit 106 varies, such as when the chassis of the device is capacitively coupled to ground as shown in FIG. 3. In embodiments, the dynamic impedance circuit may be coupled to the device in series with a Y-capacitor to the switching power supply as shown in FIGS. 3-8.

At block 1106, an impedance is varied responsive to varying the voltage across the dynamic impedance circuit. For example, the impedance is increased (at block 1106) as a voltage difference between the switching power supply and the device power circuit increases (at block 1104) responsive to a chassis of the device being coupled to ground, such as when user contact with the chassis of the device capacitively couples the device to ground. As described with reference to FIG. 3, the voltage across the dynamic impedance circuit 308 increases when user contact at 312 and/or 314 with a chassis 316 of the device capacitively couples the device to ground, as represented by capacitors 318, 320 in the illustration.

At block 1108, a determination is made as to whether there is an alternate path to ground, such as when user contact with the chassis of the device capacitively couples the device to ground via the user. If there is not an alternate path to ground (i.e., “no” from block 1108), then at block 1110, the dynamic impedance circuit operates with a low impedance. For example, the dynamic impedance circuit 408 (FIG. 4) operates with low impedance when a voltage across the circuit is minimal or decreases. Similarly, the dynamic impedance circuit 510 (FIG. 5) operates with a low impedance when a user initiates a touch input to the touch-screen of the device without holding the device in the other hand, or generally, without contacting the chassis of the device that would otherwise capacitively couple the device to ground.

Further, at block 1112, common mode noise is attenuated through the dynamic impedance circuit when the dynamic impedance circuit operates with low impedance. For example, the dynamic impedance circuit 408 attenuates common mode noise at least when the circuit operates with low impedance. The method can then continue at block 1108 to determine whether there is an alternate path to ground when the device is coupled to a switching power supply at block 1102.

If there is an alternate path to ground (i.e., “yes” from block 1108), then at block 1114, the dynamic impedance circuit operates with high impedance. For example, the dynamic impedance circuit 308 operates with high impedance responsive to the voltage across the dynamic impedance circuit increasing, such as when user contact with the chassis 316 of the device capacitively couples the device to ground. Further, at block 1116, current flow is reduced through the dynamic impedance circuit when the dynamic impedance circuit operates with high impedance. For example, current through the dynamic impedance circuit 308 is reduced when the voltage across the circuit increases. The method can then continue at block 1108 to determine whether there is an alternate path to ground while the device is coupled to a switching power supply at block 1102.

FIG. 12 illustrates various components of an example device 1200 that can be implemented as a powered device as described with reference to any of the previous FIGS. 1-11. The device may be implemented as any one or combination of a fixed or mobile device, in any form of a consumer, computer, portable, user, communication, phone, navigation, gaming, media playback, and/or electronic device.

The device 1200 includes communication devices 1202 that enable wired and/or wireless communication of device data 1204, such as received data, data that is being received, data scheduled for broadcast, data packets of the data, etc. The device also includes one or more data inputs 1206 via which any type of data, media content, and/or inputs can be received, such as user-selectable inputs, messages, music, television content, recorded video content, and any other type of audio, video, and/or image data received from any content and/or data source.

The device 1200 also includes communication interfaces 1208, such as any one or more of a serial, parallel, network, or wireless interface. The communication interfaces provide a connection and/or communication links between the device and a communication network by which other electronic, computing, and communication devices communicate data with the device.

The device 1200 includes one or more processors 1210 (e.g., any of microprocessors, controllers, and the like), which process computer-executable instructions to control operation of the device. Alternatively or in addition, the device can be implemented with any one or combination of software, hardware, firmware, or fixed logic circuitry that is implemented in connection with processing and control circuits, which are generally identified at 1212.

In embodiments, the device 1200 can be implemented with a power circuit 1214 and a dynamic impedance circuit 1216 as described with reference to any the previous FIGS. 1-11. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 1200 also includes one or more memory devices 1218 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The device 1200 may also include a mass storage media device.

A memory device 1218 provides data storage mechanisms to store the device data 1204, other types of information and/or data, and various device applications 1220. For example, an operating system 1222 can be maintained as a software application with a memory device and executed on processors 1210. The device applications may also include a device manager, such as any form of a control application, software application, signal-processing and control module, code that is native to a particular device, a hardware abstraction layer for a particular device, and so on.

The device 1200 also includes an audio and/or video processing system 1224 that generates audio data for an audio system 1226 and/or generates display data for a display system 1228. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device, such as an integrated capacitive touch-screen.

Although embodiments of a dynamic impedance circuit have been described in language specific to features and/or methods, the subject of the appended claims is not necessarily limited to the specific features or methods described. Rather, the specific features and methods are disclosed as example implementations of dynamic impedance circuits.

1. A device, comprising:
a power circuit configured to power or charge the device when connected to a power source; and
a dynamic impedance circuit coupled to the power circuit and to the power source, the dynamic impedance circuit configured to operate with low impedance, and further configured to operate with high impedance responsive to an increased voltage across the dynamic impedance circuit.

2. The device as recited in claim 1, wherein the dynamic impedance circuit comprises a Y-capacitor configured to electrically isolate the device from the power source in an event the power circuit fails.

3. The device as recited in claim 1, wherein the dynamic impedance circuit includes circuit components comprising at least one of varactor diodes, junction-gate field effect transistors (JFETs), or a negative resistor.

4. The device as recited in claim 3, wherein the circuit components of the dynamic impedance circuit are coupled to the power circuit in series with a Y-capacitor.

5. The device as recited in claim 1, wherein the power circuit is coupled to a switching power supply, and wherein the dynamic impedance circuit is coupled between a transformer primary of the switching power supply and a transformer secondary of the switching power supply.

6. The device as recited in claim 1, wherein the dynamic impedance circuit is configured to increase impedance as a voltage difference between the power circuit and the power source increases.

7. The device as recited in claim 1, wherein the dynamic impedance circuit is configured to reduce current flow when the dynamic impedance circuit operates with said high impedance.

8. The device as recited in claim 1, wherein the dynamic impedance circuit is configured to attenuate common mode noise generated by the power circuit when the dynamic impedance circuit operates with said low impedance.

9. A system, comprising:
a device that includes a capacitive touch-screen;
a switching power supply configured to power or charge the device; and
a dynamic impedance circuit coupled to a power circuit of the device and to the switching power supply, the dynamic impedance circuit configured to operate with high impedance responsive to an increasing voltage difference between the power circuit and the switching power supply.

10. The system as recited in claim 9, wherein the switching power supply is external to the device.

11. The system as recited in claim 9, wherein the dynamic impedance circuit includes circuit components comprising at least one of varactor diodes, junction-gate field effect transistors (JFETs), or a negative resistor.

12. The system as recited in claim 11, wherein the dynamic impedance circuit further comprises a Y-capacitor configured to electrically isolate the device from the switching power supply in an event the power circuit fails, and wherein the circuit components of the dynamic impedance circuit are coupled to the power circuit of the device in series with the Y-capacitor.

13. The system as recited in claim 9, wherein the dynamic impedance circuit is coupled between a transformer primary of the switching power supply and a transformer secondary of the switching power supply that is coupled to the device.

14. The system as recited in claim 9, wherein the dynamic impedance circuit is configured to reduce current flow as the voltage across the dynamic impedance circuit increases.

15. The system as recited in claim 9, wherein the dynamic impedance circuit is configured to attenuate common mode noise generated by the switching power supply when the dynamic impedance circuit operates with low impedance.

16. A method, comprising:
charging a device coupled to a switching power supply; and
varying an impedance across a dynamic impedance circuit responsive to varying a voltage between the device and the switching power supply across the dynamic impedance circuit that is coupled to the device and to the switching power supply.

17. The method as recited in claim 16, further comprising increasing the impedance as the voltage across the dynamic impedance circuit increases.

18. The method as recited in claim 16, further comprising:
operating with low impedance when there is a touch input to a capacitive touch-screen of the device; and
operating with high impedance responsive to the voltage increasing when user contact with a chassis of the device capacitively couples the device to ground.

19. The method as recited in claim 16, further comprising attenuating common mode noise through the dynamic impedance circuit when the dynamic impedance circuit operates with low impedance.

20. The method as recited in claim 16, further comprising reducing current flow with the dynamic impedance circuit when the dynamic impedance circuit operates with high impedance.
